(19) United States
(12) Patent Application Publication
(10) Pub. No.: US 2023/0094242 A1
(43) Pub. Date: Mar. 30, 2023

(54) NONAQUEOUS ELECTROLYTE SECONDARY BATTERY

(71) Applicant: SANYO Electric Co., Ltd., Kadoma-shi, Osaka (JP)

(72) Inventors: Shinichi Yamami, Hyogo (JP); Kentaro Takahashi, Hyogo (JP)

(73) Assignee: SANYO Electric Co., Ltd., Kadoma-shi, Osaka (JP)

(21) Appl. No.: 17/910,217

(22) PCT Filed: Feb. 8, 2021
(86) PCT No.: PCT/JP2021/004627

§ 371 Date: Sep. 8, 2022

(30) Foreign Application Priority Data
Mar. 13, 2020 (JP) 2020-043927

(51) Int. Cl. H01M 10/0567; H01M 4/587; H01M 4/133; H01M 4/36; H01M 4/62; H01M 10/0568

(52) U.S. Cl. CPC H01M 10/0567; H01M 4/587; H01M 4/133; H01M 4/366; H01M 4/625; H01M 10/0568; H01M 2004/027

(57) ABSTRACT

This nonaqueous electrolyte secondary battery is provided with a positive electrode, a negative electrode, and a nonaqueous electrolyte. The negative electrode has a negative electrode core body and a negative electrode mixture layer formed on the surface of the negative electrode core body. The negative electrode mixture layer contains: a negative electrode active material which has a pore volume of 0.5 ml/g or less and in which a coating layer containing a first amorphous carbon and a second amorphous carbon is formed on the surfaces of graphite particles; and a third amorphous carbon serving as a conductive material. The nonaqueous electrolyte contains difluorophosphate and a lithium salt including an oxalate complex as an anion.

### TECHNICAL FIELD

The present disclosure generally relates to a non-aqueous electrolyte secondary battery.

### BACKGROUND ART

Conventionally, non-aqueous electrolyte secondary batteries such as lithium-ion secondary batteries have been widely used as driving power supplies of mobile information terminals such as cellular phones and laptop computers. The non-aqueous electrolyte secondary batteries are also used as driving power supplies of electric vehicles (EV), hybrid electric vehicles (HEV), and the like. Commonly used for a negative electrode active material of the non-aqueous electrolyte secondary battery are a highly crystalline carbon material, such as a natural graphite and an artificial graphite, or an amorphous carbon material.

In the non-aqueous electrolyte secondary battery, the negative electrode active material and a non-aqueous electrolyte significantly affect battery performances such as low-temperature characteristic and durability. For example, Patent Literature 1 discloses a non-aqueous electrolyte secondary battery with improved battery durability (a storage characteristic and a cycle characteristic) by using lithium bisoxalate borate and lithium difluorophosphate as additives of an electrolyte liquid. Patent Literature 2 discloses a non-aqueous electrolyte secondary battery, comprising: a positive electrode; a negative electrode having a negative electrode mixture layer including a negative electrode active material; and a non-aqueous electrolyte, wherein the negative electrode active material includes coated graphite particles in which a surface of graphite particles is coated with a coating layer including a first amorphous carbon and a second amorphous carbon, the negative electrode mixture layer includes the coated graphite particles and a third amorphous carbon as a conductive agent, and the non-aqueous electrolyte includes a difluorophosphate salt and a lithium salt having an oxalate complex as an anion.

### CITATION LIST

### Patent Literature

### PATENT LITERATURE 1: Japanese Unexamined Patent Application Publication No. 2007-180015

### PATENT LITERATURE 2: Japanese Unexamined Patent Application Publication No. 2018-163833

### SUMMARY

Conventional non-aqueous electrolyte secondary batteries, which include Patent Literature 1 and Patent Literature 2, still have a room for improvement in low-temperature characteristic and durability. In addition, lithium may precipitate on the negative electrode, and the conventional non-aqueous electrolyte secondary batteries also have a room for improvement in inhibition of the lithium precipitation.

A non-aqueous electrolyte secondary battery according to the present disclosure is a non-aqueous electrolyte secondary battery comprising: a positive electrode; a negative electrode; and a non-aqueous electrolyte, wherein the negative electrode has a negative electrode core and a negative electrode mixture layer formed on a surface of the negative electrode core, the negative electrode mixture layer includes: a negative electrode active material in which a coating layer containing a first amorphous carbon and a second amorphous carbon is formed on a particle surface of a graphite and which has a pore volume of 0.5 ml/g or less; and a third amorphous carbon as a conductive agent, and the non-aqueous electrolyte includes a difluorophosphate salt and a lithium salt having an oxalate complex as an anion.

The non-aqueous electrolyte secondary battery according to the present disclosure is unlikely to precipitate lithium, and has excellent low-temperature characteristic and durability.

### BRIEF DESCRIPTION OF DRAWINGS

FIG. 1 is a perspective view illustrating an appearance of a non-aqueous electrolyte secondary battery of an example of an embodiment.

FIG. 2 is a perspective view of an electrode assembly of an example of an embodiment.

FIG. 3 is a sectional view of an electrode assembly of an example of an embodiment.

### DESCRIPTION OF EMBODIMENTS

As described above, it is considered that adding lithium bisoxalate borate and lithium difluorophosphate into the non-aqueous electrolyte forms a coating derived therefrom on the surface of the negative electrode active material enables to improve the battery durability. However, investigation by the present inventors has found that such a coating increases resistance of the negative electrode to inhibit smooth occlusion of lithium ions into the negative electrode active material, easily leading to precipitation of lithium on the negative electrode surface.

The present inventors have made intensive investigation to solve the above problem, and as a result, found that, in a non-aqueous electrolyte secondary battery including a difluorophosphate salt and a lithium salt having an oxalate complex as an anion, using first to third amorphous carbons for a negative electrode and regulating a pore volume of a negative electrode active material to be 0.5 ml/g or less highly inhibit the precipitation of lithium to remarkably increase low-temperature characteristic and durability.

The three amorphous carbons increase electron conductivity of the negative electrode and inhibit an increase in the resistance of an electrode plate due to the formation of the coating, and play an important role in the inhibition of the lithium precipitation and the increase in low-temperature characteristic and the durability. Furthermore, setting the pore volume of the negative electrode active material to be 0.5 ml/g or less specifically improves these characteristics. This is presumably because reducing the pore volume increases electron conductivity inside particles of the negative electrode active material and reduces an amount of the electrolyte liquid permeating inside the particles to inhibit a side reaction.

Hereinafter, an example of an embodiment of a non-aqueous electrolyte secondary battery according to the present disclosure will be described in detail with reference to the drawings. It is anticipated in advance to selectively combine a plurality of embodiments and modified examples exemplified below. The description “a numerical value A to a numerical value B” herein means “the numerical value A or more and the numerical value B or less”, unless otherwise specified.

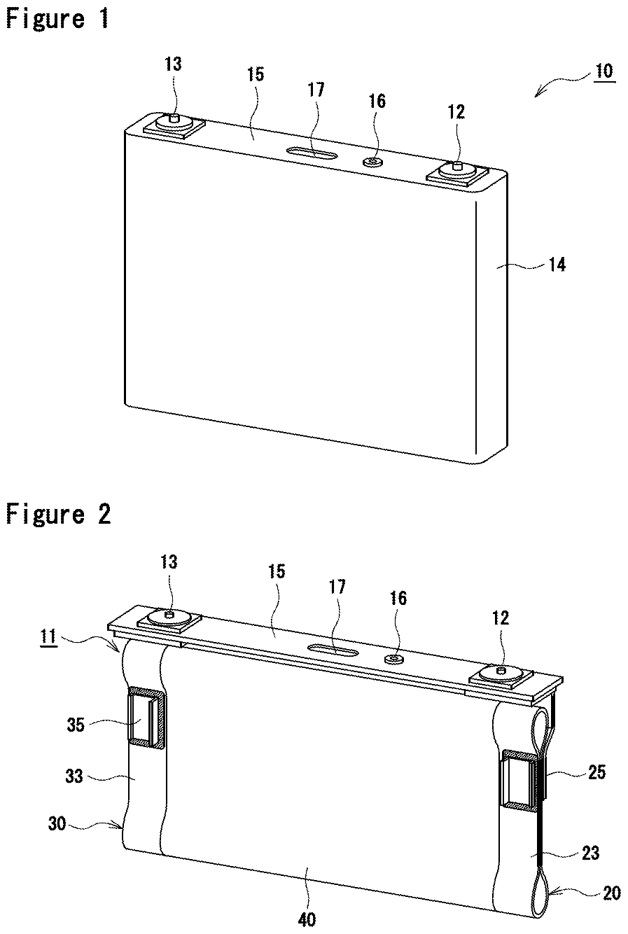

FIG. 1 is a perspective view illustrating an appearance of a non-aqueous electrolyte secondary battery 10 of an example of an embodiment. FIG. 2 is a perspective view of an electrode assembly 11 constituting the non-aqueous electrolyte secondary battery 10. The non-aqueous electrolyte secondary battery 10 illustrated in FIG. 1 comprises a bottomed rectangular-cylindrical outer housing can 14 as an outer housing body, but the outer housing body is not limited thereto. The non-aqueous electrolyte secondary battery according to the present disclosure may be, for example, a cylindrical battery comprising a bottomed cylindrical outer housing can, a coin battery comprising a coin-shaped outer housing can, or a laminate battery comprising an outer housing body constituted with a laminated sheet including a metal layer and a resin layer.

As illustrated in FIG. 1 and FIG. 2, the non-aqueous electrolyte secondary battery 10 comprises: the electrode assembly 11; a non-aqueous electrolyte; the bottomed rectangular-cylindrical outer housing can 14 housing the electrode assembly 11 and the non-aqueous electrolyte; and a sealing plate 15 sealing an opening of the outer housing can 14. The non-aqueous electrolyte secondary battery 10 is a so-called rectangular battery. The electrode assembly 11 has a wound structure in that a positive electrode 20 and a negative electrode 30 are wound with a separator 40 interposed therebetween. Any of the positive electrode 20, the negative electrode 30, and the separator 40 is a band-shaped elongate body, and the positive electrode 20 and the negative electrode 30 are stacked with the separator 40 interposed therebetween to be wound on the winding axis. The electrode assembly may be a stacked electrode assembly in which a plurality of positive electrodes and a plurality of negative electrodes are alternately stacked one by one with a separator interposed therebetween.

The non-aqueous electrolyte secondary battery 10 comprises: a positive electrode terminal 12 electrically connected to the positive electrode 20 with a positive electrode current collector 25 interposed therebetween; and a negative electrode terminal 13 electrically connected to the negative electrode 30 with a negative electrode current collector 35 interposed therebetween. In the present embodiment, the sealing plate 15 has an elongate rectangular shape, and the positive electrode terminal 12 is disposed on one end side in the longitudinal direction of the sealing plate 15, and the negative electrode terminal 13 is disposed on the other end side in the longitudinal direction of the sealing plate 15. The positive electrode terminal 12 and the negative electrode terminal 13 are external connection terminals to be electrically connected to another non-aqueous electrolyte secondary battery 10, each electronic device, and the like, and attached to the sealing plate 15 with an insulating member interposed therebetween.

Hereinafter, for convenience of description, the height direction of the outer housing can 14 will be described as “the upper-lower direction” of the non-aqueous electrolyte secondary battery 10, the sealing plate 15 side will be described as “the upper side”, and the bottom side of the outer housing can 14 will be described as “the lower side”. The direction along the longitudinal direction of the sealing plate 15 will be described as “the lateral direction” of the non-aqueous electrolyte secondary battery 10.

The outer housing can 14 is a bottomed rectangular-cylindrical metal container. An opening formed on the upper end of the outer housing can 14 is sealed by, for example, welding the sealing plate 15 with an edge part of the opening. Provided on the sealing plate 15 are typically a liquid injecting part 16 for injecting the non-aqueous electrolyte liquid, a gas discharging vent 17 to open and discharge gas with abnormality in battery, and a current-cutting mechanism. The outer housing can 14 and the sealing plate 15 are constituted with, for example, a metal material mainly composed of aluminum.

The electrode assembly 11 is a flat, wound electrode assembly including a flat part and a pair of curved parts. The electrode assembly 11 is housed in the outer housing can 14 in a state where the winding axial direction is along the lateral direction of the outer housing can 14, and the width direction of the electrode assembly 11 with aligning the pair of the curved parts is along the height direction of the battery. In the present embodiment, a current collecting part on the positive electrode side in which a core exposed part 23 of the positive electrode 20 is stacked is formed on one end part in the axial direction of the electrode assembly 11, and a current collecting part on the negative electrode side in which a core exposed part 33 of the negative electrode 30 is stacked is formed on the other end part in the axial direction. Each current collecting part is electrically connected to a terminal with a current collector interposed therebetween. An insulating electrode assembly holder (insulating sheet) may be interposed between the electrode assembly 11 and an internal surface of the outer housing can 14.

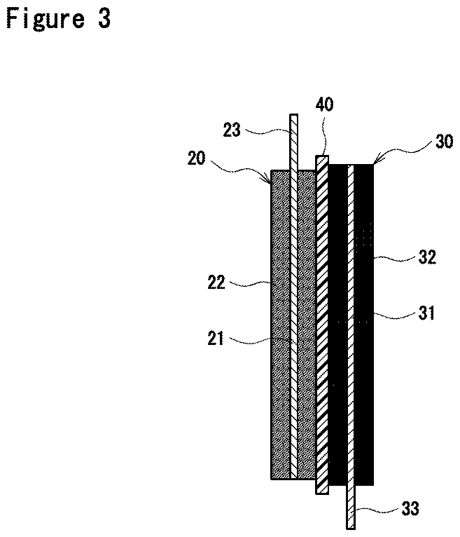

Hereinafter, the positive electrode 20, the negative electrode 30, and the separator 40, which constitute the electrode assembly 11, particularly the negative electrode 30, will be described in detail with reference to FIG. 3. The non-aqueous electrolyte will also be described in detail.

### Positive Electrode

As illustrated in FIG. 3, the positive electrode 20 has a positive electrode core 21 and a positive electrode mixture layer 22 formed on a surface of the positive electrode core 21. For the positive electrode core 21, a foil of a metal stable within a potential range of the positive electrode 20, such as aluminum and an aluminum alloy, a film in which such a metal is disposed on a surface layer thereof, and the like may be used. The positive electrode mixture layer 22 includes a positive electrode active material, a conductive agent, and a binder, and is preferably formed on both surfaces of the positive electrode core 21. In the present embodiment, the core exposed part 23 where a surface of the core is exposed along the longitudinal direction is formed on one end part in the width direction of the positive electrode 20. The positive electrode 20 may be produced by, for example, applying a positive electrode mixture slurry including the positive electrode active material, the conductive agent, the binder, and the like on the positive electrode core 21, drying and subsequently compressing the applied film to form the positive electrode mixture layers 22 on both the surfaces of the positive electrode core 21.

For the positive electrode active material, a lithium-transition metal composite oxide is used. Examples of metal elements contained in the lithium-transition metal composite oxide include Ni, Co, Mn, Al, B, Mg, Ti, V, Cr, Fe, Cu, Zn, Ga, Sr, Zr, Nb, In, Sn, Ta, and W. Among them, at least one of the group consisting of Ni, Co, and Mn is preferably contained. A preferable example of the composite oxide is a lithium-transition metal composite oxide containing Ni, Co, and Mn, or a lithium-transition metal composite oxide containing Ni, Co, and Al.

Examples of the conductive agent included in the positive electrode mixture layer 22 may include a carbon material such as carbon black, acetylene black, Ketjenblack, and graphite. Examples of the binder included in the positive electrode mixture layer 22 may include a fluororesin such as polytetrafluoroethylene (PTFE) and polyvinylidene fluoride (PVdF), polyacrylonitrile (PAN), a polyimide resin, an acrylic resin, and a polyolefin resin. With these resins, a cellulose derivative such as carboxymethyl cellulose (CMC) or a salt thereof, polyethylene oxide (PEO), and the like may be used in combination.

### Negative Electrode

The negative electrode 30 has a negative electrode core 31 and a negative electrode mixture layer 32 formed on a surface of the negative electrode core 31. For the negative electrode core 31, a foil of a metal stable within a potential range of the negative electrode 30, such as copper, a film in which such a metal is disposed on a surface layer thereof, and the like may be used. In the present embodiment, the core exposed part 33 where a surface of the core is exposed along the longitudinal direction is formed on one end part in the width direction of the negative electrode 30. The positive electrode 20 and the negative electrode 30 are stacked with the separator 40 interposed therebetween so that the core exposed parts 23 and 33 are positioned opposite to the axial direction of the electrode assembly 11. The negative electrode 30 may be produced by, for example, applying a negative electrode mixture slurry including the negative electrode active material, and the like on the surface of the negative electrode core 31, drying and subsequently compressing the applied film to form the negative electrode mixture layers 32 on both the surfaces of the negative electrode core 31.

The negative electrode mixture layer 32 includes: a negative electrode active material in which a coating layer containing a first amorphous carbon and a second amorphous carbon is formed on a particle surface of a graphite and which has a pore volume of 0.5 ml/g or less; and a third amorphous carbon as a conductive agent. The negative electrode mixture layer 32 includes a binder, and is preferably formed on both surfaces of the negative electrode core 31. Graphite constituting the negative electrode active material is a natural graphite such as flake graphite, massive graphite, and amorphous graphite, or an artificial graphite such as massive artificial graphite (MAG) and graphitized mesophase-carbon microbead (MCMB). As the negative electrode active material, metals that form an alloy with lithium such as Si and Sn, a compound thereof, or the like may be used in combination.

As described above, the negative electrode active material is of core-shell particles in which graphite particles are cores and the coating layer containing the first and second amorphous carbons is a shell. The coating layer may contain another material as long as an object of the present disclosure is not impaired, and may be constituted with substantially only the first and second amorphous carbons. The coating layer has a structure in which particles of the second amorphous carbon are dispersed in the first amorphous carbon being formed in layers. For example, the first amorphous carbon is formed in a wide range on the particle surface of graphite, and the second amorphous carbon is scatteringly present on the particle surface of graphite.

The first amorphous carbon is preferably present at an amount of 0.5 to 8 mass %, and more preferably 1 to 5 mass %, based on a mass of the negative electrode active material. The second amorphous carbon is preferably present at an amount of 1 to 15 mass %, and more preferably 2 to 10 mass %, based on a mass of the negative electrode active material. The content of the second amorphous carbon may be the same as or lower than the content of the first amorphous carbon, but preferably higher than the content of the first amorphous carbon.

For the first amorphous carbon, a sintered product of pitch (petroleum pitch or coal-tar pitch), a sintered product of a carbonizable resin such as a phenolic resin, a sintered product of heavy oil, and the like are used, for example. Among them, the sintered product of pitch is preferable. The first amorphous carbon may be formed on the particle surface of graphite by a CVD method using acetylene, methane, or the like. The first amorphous carbon also functions as a binder that binds the second amorphous carbon to the particle surface of graphite.

The second amorphous carbon preferably has a higher electric conductivity than the first amorphous carbon. The second amorphous carbon has a particle shape such as particulate (spherical), massive, acicular, and fibric shapes. For the second amorphous carbon, acetylene black, Ketjenblack, carbon black, or the like is used, for example. Among them, carbon black is preferable. The second amorphous carbon, which has a higher electric conductivity than the first amorphous carbon, more effectively increases electron conductivity of the negative electrode 30.

A median diameter on a volumetric basis (hereinafter, referred to as “D50”) of the negative electrode active material is, for example, 3 μm to 30 μm, and preferably 5 μm to 15 μm. The negative electrode mixture layer 32 may include two or more active materials having different D50s. The D50, also referred to as a median diameter, means a particle diameter at which a cumulative frequency is 50% from a smaller particle diameter side in a particle size distribution on a volumetric basis. A particle size distribution of the negative electrode active material may be measured by using a laser diffraction-type particle size distribution measuring device (for example, MT3000II, manufactured by MicrotracBEL Corp.) with water as a dispersion medium.

Although the negative electrode active material has voids in graphite particles, using first to third amorphous carbons and regulating the pore volume of the negative electrode active material to be 0.5 ml/g or less highly inhibit the precipitation of lithium to specifically increase the low-temperature characteristic and the durability. The pore volume of the negative electrode active material may be measured by using a mercury porosimeter (AutoPore IV9510 model, manufactured by Micromeritics Instrument Corp.).

A lower limit of the pore volume of the negative electrode active material is not particularly limited, and preferably 0.01 ml/g, and more preferably 0.05 ml/g. A preferable range of the pore volume is, for example, 0.01 to 0.5 ml/g or 0.05 to 0.5 ml/g. The pore volume of the negative electrode active material may be adjusted to be 0.5 ml/g or less by, for example, compressing graphite particles with a stronger force than that in a step of compressing the negative electrode mixture layer 32 to collapse the voids. The compression of graphite particles is preferably performed before formation of the coating layer.

The negative electrode active material may be manufactured by, for example, adhering the first and second amorphous carbons to the particle surface of graphite with a reduced void amount by the compression, and then sintering this mixture. A conventionally known mixer may be used for mixing graphite particles and the amorphous carbon, and examples thereof include a rotary-vessel type mixer such as a planetary ball mill, a gas-flow stirrer, a screw-type blender, and a kneader. The sintering is performed under an inert atmosphere at a temperature of 700° C. to 900° C. for several hours, for example. This sintering carbonizes pitch to reduce the mass by approximately 30%.

As described above, the negative electrode mixture layer 32 includes the third amorphous carbon as a conductive agent, and the binder. The conductive agent may contain another material as long as an object of the present disclosure is not impaired, and may be constituted with substantially only the third amorphous carbon. For the third amorphous carbon, for example, acetylene black, Ketjenblack, carbon black, or the like is used, similar to the second amorphous carbon. The same material may be used for the second and third amorphous carbons. A content of the third amorphous carbon is preferably 1 to 10 mass %, and more preferably 2 to 5 mass %, based on a mass of the negative electrode mixture layer 32.

For the binder included in the negative electrode mixture layer 32, a fluororesin, PAN, a polyimide, an acrylic resin, a polyolefin, and the like may be used similar to that in the positive electrode 20, but styrene-butadiene rubber (SBR) is preferably used. The negative electrode mixture layer 32 preferably further includes CMC or a salt thereof, polyacrylic acid (PAA) or a salt thereof, polyvinyl alcohol (PVA), and the like. Among them, SBR; and CMC or a salt thereof, or PAA or a salt thereof are preferably used in combination.

### Separator

For the separator 40, a porous sheet having an ion permeation property and an insulation property is used. Specific examples of the porous sheet include a fine porous thin film, a woven fabric, and a nonwoven fabric. As a material for the separator 40, a polyolefin such as polyethylene, polypropylene, and a copolymer of ethylene and an α-olefin, cellulose, and the like are preferable. The separator 40 may have any of a single-layered structure and a multilayered structure. On a surface of the separator 40, a heat-resistant layer including inorganic particles, a heat-resistant layer composed of a highly heat-resistant resin such as an aramid resin, a polyimide, and a polyamideimide, and the like may be formed.

### Non-Aqueous Electrolyte

The non-aqueous electrolyte includes a non-aqueous solvent and an electrolyte salt. For the non-aqueous solvent, esters, ethers, nitriles such as acetonitrile, amides such as dimethylformamide, a mixed solvent of two or more thereof, and the like may be used, for example. The non-aqueous solvent may contain a halogen-substituted solvent in which at least some hydrogens in these solvents are substituted with halogen atoms such as fluorine. Examples of the halogen-substituted solvent include fluorinated cyclic carbonates such as fluoroethylene carbonate (FEC), fluorinated chain carbonates, and fluorinated chain carboxylates such as methyl fluoropropionate (FMP).

Examples of the esters include: cyclic carbonates such as ethylene carbonate (EC), propylene carbonate (PC), and butylene carbonate; chain carbonates such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylates such as γ-butyrolactone (GBL) and γ-valerolactone (GVL); and chain carboxylates such as methyl acetate, ethyl acetate, propyl acetate, methyl propionate (MP), and ethyl propionate. Among them, at least one selected from the group of EC, EMC, and DMC is preferably used, and a mixed solvent of EC, EMC, and DMC is particularly preferably used.

Examples of the ethers include: cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and a crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The non-aqueous electrolyte further includes a difluorophosphate salt and a lithium salt having an oxalate complex as an anion. Adding them into the non-aqueous electrolyte forms a protective coating on the surface of the negative electrode active material to increase the battery durability. Although presumed are problems such as increase in an electrode plate resistance to decrease the low-temperature characteristic and being likely to precipitate lithium with forming the protective coating, improving the negative electrode 30 as above may manage such problems to obtain good battery performances. The difluorophosphate salt and the lithium salt having an oxalate complex as an anion are dissolved in the non-aqueous solvent.

The difluorophosphate salt includes a counter cation selected from, for example, lithium, sodium, potassium, magnesium, and calcium. Among them, lithium difluorophosphate (LiPF₂O₂) with lithium counter cation is preferable. Another compound may coordinate to the lithium difluorophosphate, and another difluorophosphate salt may be used in combination.

A concentration of the difluorophosphate salt is preferably 0.01 M to 0.20 M, more preferably 0.02 M to 0.15 M, and particularly preferably 0.03 M to 0.10 M. The concentration of the difluorophosphate salt being within the above range forms a good protective coating on the surface of the negative electrode active material to increase the battery durability. The concentration of the difluorophosphate salt is preferably lower than a concentration of the lithium salt having an oxalate complex as an anion.

Examples of the lithium salt having an oxalate complex as an anion include lithium bisoxalate borate, lithium difluoro(oxalate) borate salt, lithium tris(oxalate) phosphate salt, lithium difluoro(bisoxalate) phosphate salt, and lithium tetrafluoro(oxalate) phosphate. Among them, lithium bisoxalate borate (LiBOB) is preferable.

A concentration of the lithium salt having an oxalate complex as an anion is preferably 0.01 M to 0.50 M, more preferably 0.02 M to 0.30 M, and particularly preferably 0.05 M to 0.20 M. In this case, a good protective coating is formed on the surface of the negative electrode active material to increase the battery durability. The concentration of the lithium salt having an oxalate complex as an anion is preferably higher than the concentration of the difluorophosphate salt, and for example, 1.5 to 3 times the concentration of the difluorophosphate salt.

The non-aqueous electrolyte preferably includes another lithium salt as the electrolyte salt in addition to the above lithium salt such as LiPF₂O₂ and LiBOB. Specific examples of the other lithium salt include LiBF₄, LiClO₄, LiPF₆, LiAsF₆, LiSbF₆, LiAlCl₄, LiSCN, LiCF₃SO₃, LiCF₃CO₂, LiPF₆₋ₓ(CₙF₂ₙ₊₁)ₓ (1<x<6, n represents 1 or 2), LiB₁₀Cl₁₀, LiCl, LiBr, LiI, lithium chloroborane, a lithium lower aliphatic carboxylate, and borate salts such as Li₂B₄O₇. Among them, LiPF₆ is preferable. A concentration of LiPF₆ is preferably higher than the concentrations of LiPF₂O₂ and LiBOB, and for example, 0.5 M to 1.5 M.

### EXAMPLES

Hereinafter, the present disclosure will be further described with Examples, but the present disclosure is not limited to these Examples.

### Example 1

### Production of Positive Electrode

A lithium-nickel-cobalt-manganese composite oxide represented by the composite formula LiNi_{0.35}Co_{0.35}Mn_{0.30}O₂ was used as a positive electrode active material. The positive electrode active material, polyvinylidene fluoride, and carbon black were mixed at a solid-content mass ratio of 91:3:6, and N-methyl-2-pyrrolidone (NMP) was used as a dispersion medium to prepare a positive electrode mixture slurry. Then, the positive electrode mixture slurry was applied on both surfaces of a positive electrode core made of aluminum foil excluding a part to which a positive electrode lead was connected, the applied film was dried and rolled, and then cut to a predetermined electrode size to obtain a positive electrode in which the positive electrode mixture layer was formed on both the surfaces of the positive electrode core. A filling density of the positive electrode mixture layer was set to be 2.65 g/cm³.

### Production of Negative Electrode Active Material

Graphite particles where a natural graphite was modified to be spherical was compressed with a stronger force than that in a step of rolling a negative electrode, described later, to collapse voids in the particles, and then carbon black (a second conductive agent) was mixed for mechanical fusion to adhere carbon black to a surface of graphite particles. Thereafter, graphite particles in which carbon black adhered to the particle surface and pitch were mixed to adhere pitch on the particle surface. In this time, a mass ratio of graphite particles, pitch, and carbon black was set to be 90:3:7. Subsequently, this mixture was sintered under an inert gas atmosphere at 1250° C. for 24 hours, and then the sintered product was crushed to obtain a negative electrode active material in which a coating layer made from carbon black and pitch was formed on the particle surface of graphite.

A D50 of the negative electrode active material was 9 μm, and a pore volume was 0.4 ml/g. As described above, the pore volume of the negative electrode active material was calculated from a mercury penetration level in a pressure rise from 4 kPa to 400 MPa by using a mercury porosimeter (AutoPore IV9510 model, manufactured by Micromeritics Instrument Corp.).

In the step of sintering the mixture, the mass of pitch is decreased by approximately 30% due to carbonization, but the mass of graphite particles and carbon black are substantially not decreased. The coating layer is formed on the particle surface of graphite by binding carbon black particles to the sintered product (carbonized product) of pitch. That is, the particle surface of graphite is coated with the coating layer of the sintered product of pitch, and has a state where carbon black is dispersed in the coating layer.

### Production of Negative Electrode

The obtained negative electrode active material, carbon black (third conductive agent), carboxymethyl cellulose (CMC), and styrene-butadiene rubber (SBR) were mixed at a solid-content mass ratio of 94.45:4.45:0.7:0.4, and water was used as a dispersion medium to prepare a negative electrode mixture slurry. Then, the negative electrode mixture slurry was applied on both surfaces of a negative electrode core made of copper foil excluding a part to which a negative electrode lead was connected, the applied film was dried and rolled, and then cut to a predetermined electrode size to obtain a negative electrode in which the negative electrode mixture layer was formed on both the surfaces of the negative electrode core. A filling density of the negative electrode mixture layer was set to be 1.10 g/cm³.

The filling density of the negative electrode mixture layer was calculated with the following formula by cutting a sample specimen with 10 cm² from the negative electrode, then measuring a mass A and thickness C of the sample specimen, and measuring a mass B and thickness D of the core with 10 cm².

Filling Density (g/ml)=(A−B)/[(C−D)×10 cm²]

### Preparation of Non-Aqueous Electrolyte Liquid

Ethylene carbonate (EC), ethyl methyl carbonate (EMC), and dimethyl carbonate (DMC) were mixed at a volume ratio of 3:3:4 (25° C., 1 atm). Into this mixed solvent, LiPF₆, LiPF₂O₂, and LiBOB were added to be concentrations at 1.2 M, 0.05 M, and 0.10 M, respectively. In addition, vinylene carbonate was added to have a concentration at 0.3 mass % based on a total mass of a non-aqueous electrolyte liquid to provide the non-aqueous electrolyte liquid.

### Production of Non-Aqueous Electrolyte Secondary Battery

The produced positive electrode and negative electrode were wound with a separator made of a polyolefin interposed therebetween, and flatly press-formed to obtain a flat, wound electrode assembly. In this time, the positive electrode and the negative electrode were wound so that the core exposed part of the positive electrode was positioned on one end side in the winding axis direction of the electrode assembly and the core exposed part of the negative electrode was positioned on the other end side in the winding axis direction of the electrode assembly.

An external insulating member was disposed to the battery outer surface side of the part surrounding the positive electrode terminal attaching hole provided on a sealing plate. An inner insulating member and a base part of a positive electrode current collector were disposed to the battery inner surface side of the part surrounding the positive electrode terminal attaching hole. Then, a positive electrode terminal was inserted from the outside of the battery through a through hole of the outer insulating member, the positive electrode terminal attaching hole, a through hole of the inner insulating member, and a through hole of the base part of the positive electrode current collector, and a tip part of the positive electrode terminal was caulked to the base part of the positive electrode current collector. This caulk fixed the positive electrode terminal and the positive electrode current collector on the sealing plate. The caulked part of the positive electrode terminal was welded with the base part.

An external insulating member was disposed to the battery outer surface side of the part surrounding the negative electrode terminal attaching hole provided on a sealing plate. An inner insulating member and a base part of a negative electrode current collector were disposed to the battery inner surface side of the part surrounding the negative electrode terminal attaching hole. Then, a negative electrode terminal was inserted from the outside of the battery through a through hole of the outer insulating member, the negative electrode terminal attaching hole, a through hole of the inner insulating member, and a through hole of the base part of the negative electrode current collector, and a tip part of the negative electrode terminal was caulked to the base part of the negative electrode current collector. This caulk fixed the negative electrode terminal and the negative electrode current collector on the sealing plate. The caulked part of the negative electrode terminal was welded with the base part.

Next, the positive electrode current collector was welded with the core exposed part of the positive electrode, the negative electrode current collector was welded with the core exposed part of the negative electrode, and then the electrode assembly to which the current collector was attached was covered with a resin sheet to be inserted in a rectangular outer housing can. Then, a sealing assembly was welded with a circumference edge of an opening of the outer housing can to seal the opening of the outer housing can, the non-aqueous electrolyte liquid was injected through a liquid injecting port of the sealing plate, and the liquid injecting port was sealed with a sealing plug. This procedure yielded a non-aqueous electrolyte secondary battery having a battery capacity of 5.5 Ah.

Performance evaluations were performed on the produced non-aqueous electrolyte secondary battery with the following methods. Table 1 shows the evaluation results. The values of the low-temperature characteristic, cycle characteristic, and storage characteristic shown in Table 1 are relative values relative to a value of the battery of Comparative Example 1 being 100.

### Evaluation of Low-Temperature Characteristic

The non-aqueous electrolyte secondary battery was charged under a condition at 25° C. until a charge depth of SOC (state of charge) reached 50%. Then, the battery was charged under a condition at −30° C. at a constant current of 1.6 It, 3.2 It, 4.8 It, 6.4 It, 8.0 It, and 9.6 It for each 10 seconds to measure each battery voltage. The battery voltages were plotted with respect to each current value to determine a characteristic of low-temperature regeneration (electric power (W) with 4.3-V charged) based on a product of the current value and the battery voltage value (4.3 V).

### Evaluation of Lithium Precipitation

The non-aqueous electrolyte secondary battery was charged under a condition at 25° C. until an SOC reached 60%. Then, the battery was charged under a condition at 25° C. at a constant current of 38 It for 10 seconds, discharged at a constant current of 6.8 It for 55.9 seconds, and then rested for 300 seconds. This was taken as one cycle, and 1000 cycles of charges and discharges were performed. Thereafter, the battery was disassembled to visually observe a presence of lithium precipitation on the negative electrode surface.

### Evaluation of Cycle Characteristic (Capacity Maintenance Rate)

The battery was charged under a condition at 25° C. at a constant current of 1 It until the battery voltage reached 4.1 V. Then the battery was charged at a constant voltage of 4.1 V for 1.5 hours. After a rest for 10 seconds, the battery was discharged at a constant current of 1 It until the battery voltage reached 2.5 V. A discharge capacity in this time was specified as a battery capacity before a high-temperature cycle.

Next, the battery was charged under a condition at 60° C. at a constant current of 2 It until the battery voltage reached 4.1 V. After a rest for 10 seconds, the battery was discharged at a constant current of 2 It until the battery voltage reached 3.0 V. This was taken as one cycle, and 400 cycles of charges and discharges were performed. After the 400 cycles, the battery was charged under a condition at 25° C. at a constant current of 1 It until the battery voltage reached 4.1 V. Then, the battery was charged at a constant voltage of 4.1 V for 1.5 hours. After a rest for 10 seconds, the battery was discharged at a constant current of 1 It until the battery voltage reached 2.5 V. A discharge capacity in this time was specified as a battery capacity after a high-temperature cycle, and a capacity maintenance rate was calculated with the following formula.

Capacity Maintenance Rate=Battery Capacity after High-Temperature Cycle/Battery Capacity before High-Temperature Cycle

### Evaluation of Storage Characteristic (Capacity Maintenance Rate after Storage Test)

The battery was charged under a condition at 25° C. at a constant current of 1 It until the battery voltage reached 4.1 V. Then, the battery was charged at a constant voltage of 4.1 V for 1.5 hours. After a rest for 10 seconds, the battery was discharged at a constant current of 1 It until the battery voltage reached 2.5 V. A discharge capacity in this time was specified as a battery capacity before storage.

Then, the battery was charged under a condition at 25° C. until an SOC reached 80%, and stored at 70° C. for 56 days. Thereafter, this battery was discharged until 2.5 V. Subsequently, the battery was charged at a constant current of 1 It until the battery voltage reached 4.1 V, and charged at a constant voltage of 4.1 V for 1.5 hours. Then, the battery was discharged at a constant current of 1 It until the battery voltage reached 2.5 V. A discharge capacity in this time was specified as a battery capacity after storage, and a capacity maintenance rate after the storage test was calculated with the following formula.

Capacity Maintenance Rate=Battery Capacity after Storage/Battery Capacity before Storage

### Example 2

A negative electrode and a non-aqueous electrolyte secondary battery were produced to perform performance evaluations in the same manner as in Example 1 except that: graphite particles, pitch, and carbon black were mixed at a mass ratio of 90:1:9 in the production of the negative electrode active material; and the negative electrode active material, carbon black, CMC, and SBR were mixed at a solid-content mass ratio of 93.46:5.44:0.7:0.4 in the preparation of the negative electrode mixture slurry.

### Example 3

A negative electrode and a non-aqueous electrolyte secondary battery were produced to perform performance evaluations in the same manner as in Example 1 except that: graphite particles, pitch, and carbon black were mixed at a mass ratio of 90:5:5 in the production of the negative electrode active material; and the negative electrode active material, carbon black, CMC, and SBR were mixed at a solid-content mass ratio of 95.44:3.46:0.7:0.4 in the preparation of the negative electrode mixture slurry.

### Example 4

A negative electrode and a non-aqueous electrolyte secondary battery were produced to perform performance evaluations in the same manner as in Example 1 except that graphite particles were compressed to have a pore volume of 0.5 ml/g in the production of the negative electrode active material.

### Example 5

A negative electrode and a non-aqueous electrolyte secondary battery were produced to perform performance evaluations in the same manner as in Example 1 except that graphite particles were compressed to have a pore volume of 0.1 ml/g in the production of the negative electrode active material.

### Comparative Example 1

A negative electrode and a non-aqueous electrolyte secondary battery were produced to perform performance evaluations in the same manner as in Example 1 except that: graphite particles were not compressed (pore volume of 0.8 ml/g), and graphite particles and pitch were mixed at a mass ratio of 98:2 (no carbon black was added) in the production of the negative electrode active material; no carbon black was added, and the negative electrode active material, CMC, and SBR were mixed at a solid-content mass ratio of 98.9:0.7:0.4, in the preparation of the negative electrode mixture slurry; and no LiPF₂O₂ nor LiBOB were added in the preparation of the non-aqueous electrolyte liquid.

### Comparative Example 2

A negative electrode and a non-aqueous electrolyte secondary battery were produced to perform performance evaluations in the same manner as in Comparative Example 1 except that graphite particles were compressed to have a pore volume of 0.4 ml/g in the production of the negative electrode active material.

### Comparative Example 3

A negative electrode and a non-aqueous electrolyte secondary battery were produced to perform performance evaluations in the same manner as in Comparative Example 1 except that LiPF₂O₂ and LiBOB were added to be concentrations of 0.05 M and 0.10 M, respectively, in the preparation of the non-aqueous electrolyte liquid.

### Comparative Example 4

A negative electrode and a non-aqueous electrolyte secondary battery were produced to perform performance evaluations in the same manner as in Comparative Example 2 except that graphite particles, pitch, and carbon black were mixed at a mass ratio of 90:3:7 in the production of the negative electrode active material.

### Comparative Example 5

A negative electrode and a non-aqueous electrolyte secondary battery were produced to perform performance evaluations in the same manner as in Comparative Example 2 except that the negative electrode active material, carbon black, CMC, and SBR were mixed at a solid-content mass ratio of 94.45:4.45:0.7:0.4 in the preparation of the negative electrode mixture slurry.

### Comparative Example 6

A negative electrode and a non-aqueous electrolyte secondary battery were produced to perform performance evaluations in the same manner as in Comparative Example 2 except that LiPF₂O₂ and LiBOB were added to be concentrations of 0.05 M and 0.10 M, respectively, in the preparation of the non-aqueous electrolyte liquid.

### Comparative Example 7

A negative electrode and a non-aqueous electrolyte secondary battery were produced to perform performance evaluations in the same manner as in Example 1 except that no LiPF₂O₂ nor LiBOB were added in the preparation of the non-aqueous electrolyte liquid.

### Comparative Example 8

A negative electrode and a non-aqueous electrolyte secondary battery were produced to perform performance evaluations in the same manner as in Example 1 except that no carbon black was added, and the negative electrode active material, CMC, and SBR were mixed at a solid-content mass ratio of 98.9:0.7:0.4, in the preparation of the negative electrode mixture slurry.

### Comparative Example 9

A negative electrode and a non-aqueous electrolyte secondary battery were produced to perform performance evaluations in the same manner as in Example 1 except that no carbon black was added, and graphite particles and pitch were mixed at a mass ratio of 98:2, in the production of the negative electrode active material.

### Comparative Example 10

A negative electrode and a non-aqueous electrolyte secondary battery were produced to perform performance evaluations in the same manner as in Example 1 except that graphite particles were not compressed (pore volume of 0.8 ml/g) in the production of the negative electrode active material.

TABLE 1

| | Negative electrode and negative | | | Non-aqueous | | | | |
|---|---|---|---|---|---|---|---|---|
| | electrode active material | | | electrolyte | Performance evaluation | | | |
| | Pore | Second | Third | liquid | Low- | | | |
| | volume | conductive | conductive | LiPF₂O₂ | temperature | Li | Cycle | Storage |
| | (ml/g) | agent (wt %) | agent (wt %) | LiBOB | characteristic | precipitation | characteristic | characteristic |
| Example 1 | 0.4 | 7 | 4.45 | Presence | 116 | Absence | 119 | 125 |
| Example 2 | 0.4 | 9 | 5.44 | Presence | 118 | Absence | 120 | 122 |
| Example 3 | 0.4 | 5 | 3.46 | Presence | 113 | Absence | 117 | 126 |
| Example 4 | 0.5 | 7 | 4.45 | Presence | 112 | Absence | 116 | 119 |
| Example 5 | 0.1 | 7 | 4.45 | Presence | 118 | Absence | 120 | 128 |
| Comparative | 0.8 | 0 | 0 | Absence | 100 | Presence | 100 | 100 |
| Example 1 | | | | | | | | |
| Comparative | 0.4 | 0 | 0 | Absence | 102 | Presence | 103 | 110 |
| Example 2 | | | | | | | | |
| Comparative | 0.8 | 0 | 0 | Presence | 82 | Presence | 105 | 104 |
| Example 3 | | | | | | | | |
| Comparative | 0.4 | 7 | 0 | Absence | 104 | Presence | 104 | 107 |
| Example 4 | | | | | | | | |
| Comparative | 0.4 | 0 | 4.45 | Absence | 107 | Presence | 105 | 105 |
| Example 5 | | | | | | | | |
| Comparative | 0.4 | 0 | 0 | Presence | 92 | Presence | 107 | 113 |
| Example 6 | | | | | | | | |
| Comparative | 0.4 | 7 | 4.45 | Absence | 109 | Presence | 106 | 103 |
| Example 7 | | | | | | | | |
| Comparative | 0.4 | 7 | 0 | Presence | 98 | Presence | 108 | 115 |
| Example 8 | | | | | | | | |
| Comparative | 0.4 | 0 | 4.45 | Presence | 100 | Presence | 108 | 116 |
| Example 9 | | | | | | | | |
| Comparative | 0.8 | 7 | 4.45 | Presence | 103 | Presence | 108 | 108 |
| Example 10 | | | | | | | | |

As shown in Table 1, any of the batteries in Examples had excellent low-temperature characteristic and durability (the cycle characteristic and the storage characteristic) compared with the batteries in Comparative Examples. In addition, the lithium precipitation was observed on the negative electrode surface of the batteries in Comparative Examples, but no lithium precipitation was observed in the batteries in Examples. That is, in the case where LiPF₂O₂ and LiBOB are contained in an non-aqueous electrolyte, the negative electrode active material in which a coating layer constituted of the sintered product of pitch and carbon black is formed on the particle surface of graphite and which has a pore volume of 0.5 ml/g or less is used, and carbon black is added in the negative electrode mixture layer, the non-aqueous electrolyte secondary battery in which the storage characteristic and the low-temperature characteristic are specifically improved and the lithium precipitation is highly inhibited can be obtained.

Each of the batteries in Comparative Examples is studied as follows.

Comparative Example 2: Reducing the pore volume of the negative electrode active material increased electron conductivity in the active material and increased the low-temperature characteristic, compared with the battery in Comparative Example 1. Since a side reaction with the electrolyte liquid was inhibited, the cycle characteristic and the storage characteristic were increased. However, its characteristics largely differ from those of the batteries in Examples.

Comparative Example 3: Adding LiPF₂O₂ and LiBOB into the non-aqueous electrolyte liquid increased the cycle characteristic and the storage characteristic compared with the battery in Comparative Example 1. However, the coating behaved as a resistant component to decrease the low-temperature characteristic.

Comparative Example 4: Adding carbon black into the coating layer increased the electron conductivity of the negative electrode plate and increased the low-temperature characteristic, compared with the battery in Comparative Example 2. However, the side reaction with the electrolyte liquid was enhanced to decrease the storage characteristic.

Comparative Example 5: Adding carbon black into the negative electrode mixture layer increased the electron conductivity of the negative electrode and increased the low-temperature characteristic, compared with the battery in Comparative Example 2. However, the side reaction with the electrolyte liquid was enhanced to decrease the storage characteristic.

Comparative Example 6: Adding LiPF₂O₂ and LiBOB into the non-aqueous electrolyte liquid increased the cycle characteristic and the storage characteristic compared with the battery in Comparative Example 2. However, the coating became a resistant component to decrease the low-temperature characteristic.

Comparative Example 7: Adding carbon black into the coating layer and the negative electrode mixture layer increased the electron conductivity of the negative electrode and increased the low-temperature characteristic, compared with the battery in Comparative Example 2. However, the side reaction with the electrolyte liquid was enhanced to decrease the storage characteristic.

Comparative Example 8: Adding carbon black into the coating layer increased the electron conductivity of the negative electrode plate and increased the low-temperature characteristic, the cycle characteristic, and the storage characteristic, compared with the battery in Comparative Example 6. However, its characteristics largely differ from those of the batteries in Examples.

Comparative Example 9: Adding carbon black into the negative electrode mixture layer increased the electron conductivity of the negative electrode and increased the low-temperature characteristic, the cycle characteristic, and the storage characteristic, compared with the battery in Comparative Example 6. However, its characteristics largely differ from those of the batteries in Examples.

Comparative Example 10: The constitution was same as that of the battery in Example 1 except that the pore volume of the negative electrode active material exceeded 0.5 ml/g. However, the low-temperature characteristic, the cycle characteristic, and the storage characteristic were inferior to the battery in Example 1. In addition, the lithium precipitation on the negative electrode surface was observed.

### REFERENCE SIGNS LIST

10 Non-aqueous electrolyte secondary battery
11 Electrode assembly
12 Positive electrode terminal
13 Negative electrode terminal
14 Outer housing can
15 Sealing plate
16 Liquid injecting part
17 Gas discharging vent
20 Positive electrode
21 Positive electrode core
22 Positive electrode mixture layer
23, 33 Core exposed part
25 Positive electrode current collector
30 Negative electrode
31 Negative electrode core
32 Negative electrode mixture layer
35 Negative electrode current collector
40 Separator

1. A non-aqueous electrolyte secondary battery, comprising:
a positive electrode;
a negative electrode; and
a non-aqueous electrolyte, wherein
the negative electrode has a negative electrode core and a negative electrode mixture layer formed on a surface of the negative electrode core,
the negative electrode mixture layer includes: a negative electrode active material in which a coating layer containing a first amorphous carbon and a second amorphous carbon is formed on a particle surface of a graphite and which has a pore volume of 0.5 ml/g or less; and a third amorphous carbon as a conductive agent, and
the non-aqueous electrolyte includes a difluorophosphate salt and a lithium salt having an oxalate complex as an anion.

2. The non-aqueous electrolyte secondary battery according to claim 1, wherein the coating layer has a structure in which particles of the second amorphous carbon are dispersed in the first amorphous carbon being formed in layers.

3. The non-aqueous electrolyte secondary battery according to claim 1, wherein the second amorphous carbon has a higher electric conductivity than the first amorphous carbon.

4. The non-aqueous electrolyte secondary battery according to claim 1, wherein
the first amorphous carbon is a sintered product of pitch, and
the second amorphous carbon and the third amorphous carbon are carbon black.

5. The non-aqueous electrolyte secondary battery according to claim 1, wherein the difluorophosphate salt is lithium difluorophosphate.

6. The non-aqueous electrolyte secondary battery according to claim 1, wherein the lithium salt having an oxalate complex as an anion is lithium bisoxalate borate.
